(19) United States
(12) Patent Application Publication
(10) Pub. No.: US 2008/0151060 A1
(43) Pub. Date: Jun. 26, 2008

(54) Camera apparatus and chapter data generating method in camera apparatus

(75) Inventors: Kenichi Shinotsuka, Tokyo (JP); Shiro Nagaoka, Tokyo (JP); Toyokazu Aizawa, Tokyo (JP); Tatsuhiko Ikehata, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/980,582

(22) Filed: Oct. 31, 2007

(30) Foreign Application Priority Data
Dec. 25, 2006 (JP) 2006-348104

(51) Int. Cl. H04N 5/225

(52) U.S. Cl. 348/207.1; 348/E05.001

(57) ABSTRACT

According to one embodiment, a camera apparatus includes a chapter data generating unit generating chapter data specifying a reproduction start point of moving image data corresponding to a time point at which a scene change occurs, when the scene change occurs during generation of the moving image data indicating a shot video.

### CROSS-REFERENCE TO RELATED APPLICATIONS

This application is based upon and claims the benefit of priority from Japanese Patent Application No. 2006-348104, filed Dec. 25, 2006, the entire contents of which are incorporated herein by reference.

### BACKGROUND

1. Field

One embodiment of the invention relates to a camera apparatus generating moving image data indicating a shot video that is shot, such as a digital camera, a video camera and the like, and a chapter generating method in the camera apparatus.

2. Description of the Related Art

Conventionally, there is known a camera apparatus (also called an electronic camera apparatus) importing an optical image of a subject as a still image or a moving image, converting such shot image into image data and electronically saving the data. As a conventional camera apparatus, there are a digital camera mainly shooting a still image and a video camera mainly shooting a moving image.

Conventionally, a variety of the digital cameras and video cameras are widely spread. For example, in Japanese Patent Application Publication (KOKAI) No. 2005-79823 (Patent Document 1), there is disclosed a video camera storing moving image data divided into a plurality of chapters and displaying a representative image of each chapter.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing main components of a camera apparatus according to an embodiment of the invention;

FIG. 2 is an exemplary view showing data structure of moving image data compressed by a compression/decompression processing unit in compliance with MPEG-2 in the embodiment;

FIG. 3 is an exemplary view showing structure of the moving image data also compressed by the compression/decompression processing unit in compliance with MPEG-2, with GOPs being displayed together with a chapter table in the embodiment;

FIG. 4 is an exemplary view schematically showing moving image data in a case that chapter automatic insertion is performed in the embodiment;

FIG. 5 is an exemplary view showing structure of moving image data in the case that the chapter automatic insertion is performed, with GOPs being displayed together with the chapter table in the embodiment;

FIG. 6 is an exemplary flowchart showing an initial setting procedure of chapter automatic insertion in the embodiment;

FIG. 7 is an exemplary flowchart showing an operating procedure of a chapter data automatic generating process in the embodiment;

FIG. 8 is an exemplary flowchart showing an operating procedure of a final process of the chapter automatic insertion in the embodiment;

FIG. 9 (a) to FIG. 9 (c) are exemplary views showing shooting menus, FIG. 9(a) showing the view of a case that chapter insertion setting is selected, FIG. 9 (b) showing the view of a case that the chapter automatic insertion is selected, and FIG. 9 (c) showing the view of a case that the chapter automatic insertion is not selected in the embodiment; and

FIG. 10 is an exemplary view showing an example of a case that moving image data divided into chapters by the chapter automatic insertion is displayed on an LCD.

### DETAILED DESCRIPTION

Various embodiments according to the invention will be described hereinafter with reference to the accompanying drawings. In general, according to one embodiment of the invention, a camera apparatus includes a chapter data generating unit generating chapter data specifying a reproduction start point of moving image data corresponding to a time point at which a scene change occurs, when the scene change occurs during generation of the moving image data indicating a shot video.

A camera apparatus includes: a moving image data generating device generating moving image data indicating a shot video; a scene change detection unit detecting a scene change during generation of the moving image data by the moving image data generating device; and a chapter data generating unit generating chapter data specifying a reproduction start point of the moving image data corresponding to a time at which the scene change is detected, when the scene change is detected by the scene change detection unit.

A chapter data generating method in a camera apparatus provided with a moving image data generating device generating moving image data indicating a shot video is as follows. That is, chapter data specifying a reproduction start point of the moving image data corresponding to a time at which a scene change occurs is generated, when the scene change occurs during generation of the moving image data by the moving image data generating device.

(Components of Camera Apparatus)

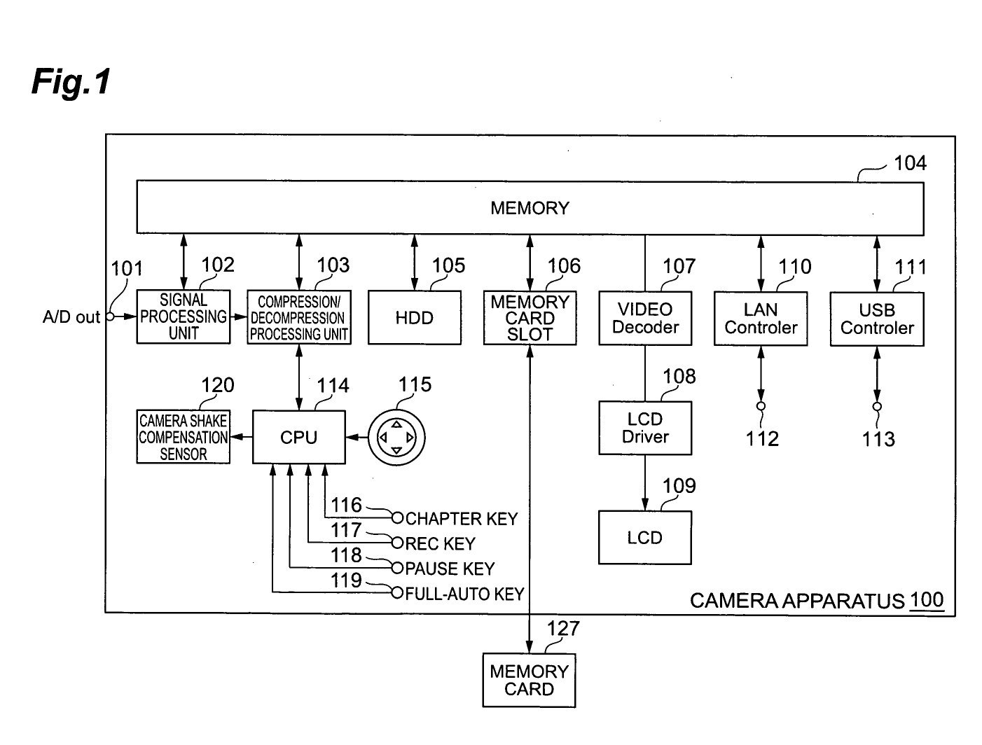

FIG. 1 is a block diagram showing main components of a camera apparatus 100 according to an embodiment of the invention. The camera apparatus 100 shown in FIG. 1 is a digital video camera apparatus shooting mainly a moving image but also is capable of shooting a still image.

The camera apparatus 100 handles data compressed in compliance with MPEG-2 when shooting or reproducing a moving image. When reproducing a moving image, the camera apparatus 100 easily provides trick reproductions such as a reverse reproduction, a high-speed reproduction, a high-speed reverse reproduction, a frame forward and a frame rewind, in addition to a normal reproduction. Further, unlike a case in which a magnetic tape is employed as an image data recording medium, a random-accessible recording medium such as a later-described HDD 105 or memory card 127 is employed in the camera apparatus 100. This allows a user to search a desired video easily.

The camera apparatus 100 includes a digital signal output unit 101, a signal processing unit 102, a compression/decompression processing unit 103, and a memory 104 and a HDD (Hard Disk Drive) 105.

The camera apparatus 100 also includes a memory card slot 106, a video decoder 107, an LCD (Liquid Crystal Display) driver 108, an LCD 109, a LAN controller 110 and a USB controller 111. Further, the camera apparatus 100 includes a LAN terminal 112, a USB terminal 113, a CPU 114, and an operation device 115, and includes four operation keys (chapter key 116, REC key 117, PAUSE key 118, FULL-AUTO key 119) and a camera shake compensation sensor 120.

The digital signal output unit 101 converts an analog electric signal, which is generated by a CCD (Charge Coupled Device) by using an optical image of a subject obtained through a not-shown lens, into a digital signal and outputs the digital signal to the signal processing unit 102.

The signal processing unit 102 has a function as a moving image data generating device performing an image processing on the inputted digital signal to thereby generate moving image data indicating a shot video actually shot. Note that the generated moving image data is once stored in the memory 104.

The compression/decompression processing unit 103 compresses the moving image data exported from the memory 104 in compliance with MPEG-2 to thereby produce compressed moving image data, or compresses still image data in compliance with JPEG to produce compressed still image data. Further, in accordance with an instruction of the CPU 114, the compression/decompression processing unit 103 decompresses the compressed moving image data and the compressed still image data.

The memory 104 temporarily stores data to be processed by the signal processing unit 102 and data to be processed by the compression/decompression processing unit 103.

The HDD 105 is an external memory apparatus recording the moving image data which has been compressed (compressed moving image data), sound data which has been compressed, and the compressed still image data in an HD (Hard Disc) built therein. The HDD 105 reads/writes data from/to the HD (Hard Disc) based on a random access.

The memory card 127 such as an SD memory card (Secure Digital memory card) is inserted into the memory card slot 106, and the memory card slot 106 reads/writes data from/to the memory card 127 inserted thereinto. The memory card 127 records the compressed moving image data and the like.

In order to display the shot video that is shot by using the compressed moving image data, the video decoder 107 performs a decoding process to the moving image data to output the data to the LCD driver 108. The video decoder 107 is a software decoder realized by a decoding program.

The LCD driver 108 converts the decoded moving image data received from the video decoder 107 into a display signal compatible with an interface of the LCD 109. The LCD 109 displays the shot video by using the display signal outputted from the LCD driver 108.

In accordance with the instruction of the CPU 114, the LAN controller 110 transfers the moving image data obtained from the memory 104 to a not-shown external apparatus (for example, a DVD recorder or an HDD recorder) connected via the LAN terminal 112. Besides, the LAN controller 110 outputs the moving image data imported from the external apparatus via the LAN terminal 112 to the memory 104.

In accordance with the instruction of the CPU 114, the USB controller 111 transfers the moving image data obtained from the memory 104 to a not-shown external apparatus (for example, a personal computer) connected via the USB terminal 113. Besides, the USB controller 111 outputs the moving image data imported from the external apparatus via the USB terminal 113 to the memory 104.

In accordance with a program stored in a not-shown ROM, the CPU 114 operates as various units/devices (a chapter data generating unit, a scene change detection unit, a judging unit) as a feature of the invention. Further, the CPU 114 inputs/outputs a signal to/from the other components to control the entire operation or the respective sequences of the camera apparatus 100.

The operation device 115 includes a jog dial and a cross key. The operation device 115 is an operation device operated by a user to select or implement various functions (for example, starting reproduction, stopping reproduction, stopping shooting, and the like) of the camera apparatus 100. When the jog dial is operated during a moving image reproduction, reproducing speed is adjusted responding to the operation.

The chapter key 116 inputs a chapter generating instruction to the CPU 114 according to a pressing operation by the user. The chapter generating instruction is data to instruct the CPU 114 to generate later-described chapter data (for example, later-described chapter data 331 and the like) and to record the generated chapter data in a chapter table 330. Incidentally, by using the chapter key 116, the chapter data can be generated by the user's manual operation. The REC key 117 inputs an instruction to start recording to the CPU 114 according to a pressing operation by the user.

The PAUSE key 118 inputs an instruction to pause recording or reproducing to the CPU 114. The FULL-AUTO key 119 can be turned on or off. If the FULL-AUTO key 119 is turned on, time point information is recorded in the later-described chapter table 330 for a time corresponding to a specific GOP, while a later-described chapter number is automatically incremented without the user's operation.

The camera shake compensation sensor 120 is a camera shake information generating device generating camera shake information, and inputs the generated camera shake information to the CPU 114. The camera shake compensation sensor 120 can be constituted with a gyro sensor such as, for example, an angular accelerometer, an angular speed meter and an angular displacement meter which detect camera shake.

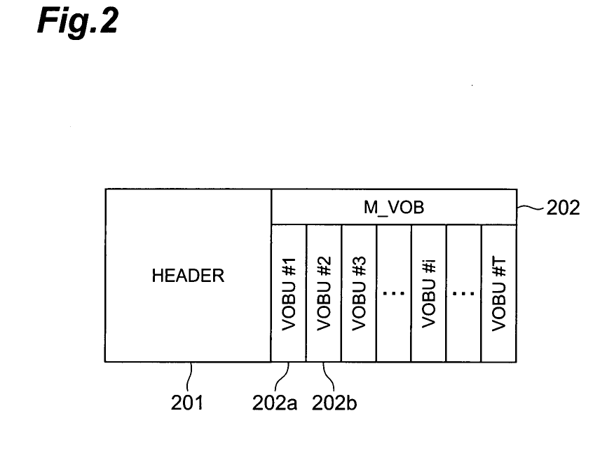

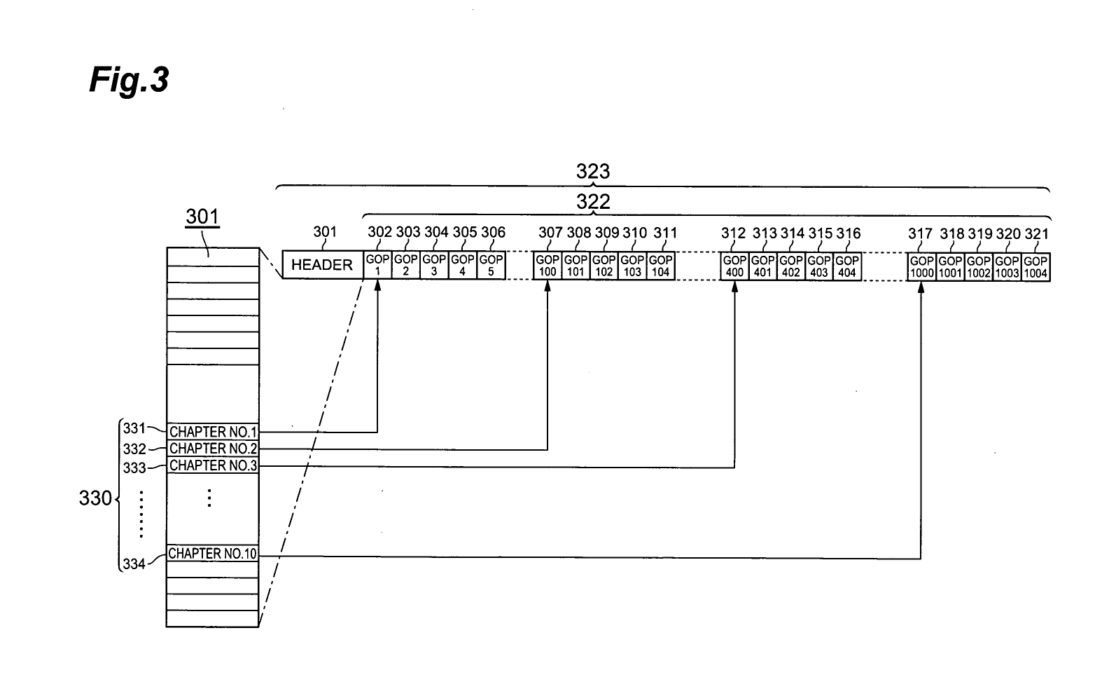

Next, the data structure of the moving image data compressed in compliance with MPEG-2 by the compression/decompression processing unit 103 will be described with reference to FIG. 2 and FIG. 3. Here, FIG. 2 is a view showing data structure of the moving image data compressed in compliance with MPEG-2 by the compression/decompression processing unit 103.

The moving image data includes a header section 201 and a data section 202. In the header section 201 there is a VOBU-ENT information section, in which a size of each VOBU (Video Object Block Unit) constituting the data section 202 is recorded. The data section 202 includes a plurality of the VOBUs (VOBU202a, 202b, etc.).

The number of the VOBU is proportional to the length of shooting time. The VOBU includes moving image data equivalent to 0.5 seconds compressed in compliance with MPEG-2, that is, a later-described GOP (Group of Pictures) and a lot of header information. For example, in a case of shooting time of 10 minutes, 1200 GOPs are generated, which is obtained by 10 minutes×60 sec./0.5. Since the size of each VOBU is recorded in the VOBU-ENT information section of the header section 201, size information of respective 1200 GOPs is recorded.

Similarly, FIG. 3 is a view showing structure of moving image data 323 compressed by the compression/decompression processing unit 103 in compliance with MPEG-2, with GOPs being displayed together with the chapter table 330. When reproducing the shot video by using the moving image data 323, in the camera apparatus 100, a certain unit of moving image or a certain pieces of moving images constitute a GOP and the moving images can be independently reproduced in a unit of GOP. The GOP includes the moving image data equivalent to 15 frames.

The moving image data 323 includes a header 301 and a moving image stream 322 indicating a shot video actually shot.

In the header 301 there is recorded management information such as initial data required by the video decoder 107 to decode the moving image data and to reproduce the shot video, such as an image size and a pixel aspect ratio.

The header 301 also includes the chapter table 330. In the chapter table 330 is recorded generated chapter data. FIG. 3 shows a state that ten pieces of chapter data (chapter data 331, 332, 333, 334) are recorded in the chapter table 330 (here, drawing of some chapter data is omitted).

Each chapter data has time point data (also referred to as PTM (Presentation Time), or time point information) and a chapter number (chapter No.) for identifying each chapter data. The time point data indicates a location of a particular GOP among the GOPs included in the moving image stream 322. For example, the chapter data 331, 332, 333, 334 respectively have time point data of GOPs 302, 307, 312, 317, and by each time point data, matching between the chapter data and the GOP is performed. The chapter data indicates a reproduction start point of the moving image data.

The moving image stream 322 is constituted as a data stream including a plurality of GOPs (GOP 302 to GOP 321), and each GOP is recorded by 0.5 seconds. Each GOP is the unit of an edit process using the operation device 115 and is data with a shooting time of 0.5 seconds.

(Operation Details of Camera Apparatus)

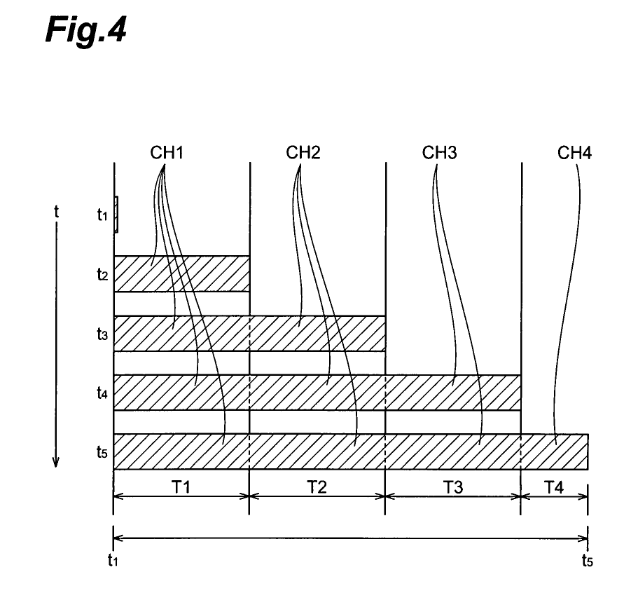

Next, operation details of the camera apparatus 100 will be described with reference to FIG. 4 to FIG. 10. At a time of shooting, the camera apparatus 100 generates the chapter data in accordance with a certain condition (when later-describe scene change occurs), and automatically records the generated chapter data per later-described chapter insertion interval (in this embodiment, recording of the chapter data as above is referred to as “chapter automatic insertion”). FIG. 4 schematically shows the moving image data in a case that the chapter automatic insertion is performed.

In FIG. 4 there is shown a case that the user starts shooting at a time t1, thereafter scene changes during the shooting are detected at times t2, t3, and t4 in time series along a time axis t, and the user stops shooting at a time t5.

In FIG. 4, the chapter data is generated every time the scene change is detected. In other words, when the scene change at the time t2 is detected, later-described chapter data 552 is generated and the moving image data from the time t1 to the time t2 is a chapter CH1. When the scene change at the time t3 is detected, later-described chapter data 553 is generated and the moving image data from the time t2 to the time t3 is a chapter CH2. Further, when the scene change at the time t4 is detected, a later-described chapter data 554 is generated, and the moving image data from the time t3 to the time t4 is a chapter CH3. The moving image data from the time t4 to the time t5 is a chapter CH4.

A period from the time t1 to the time t2 , when the first chapter data generation is performed is a chapter insertion time T1, and periods in which each chapter data is generated are chapter insertion times T2, T3, T4.

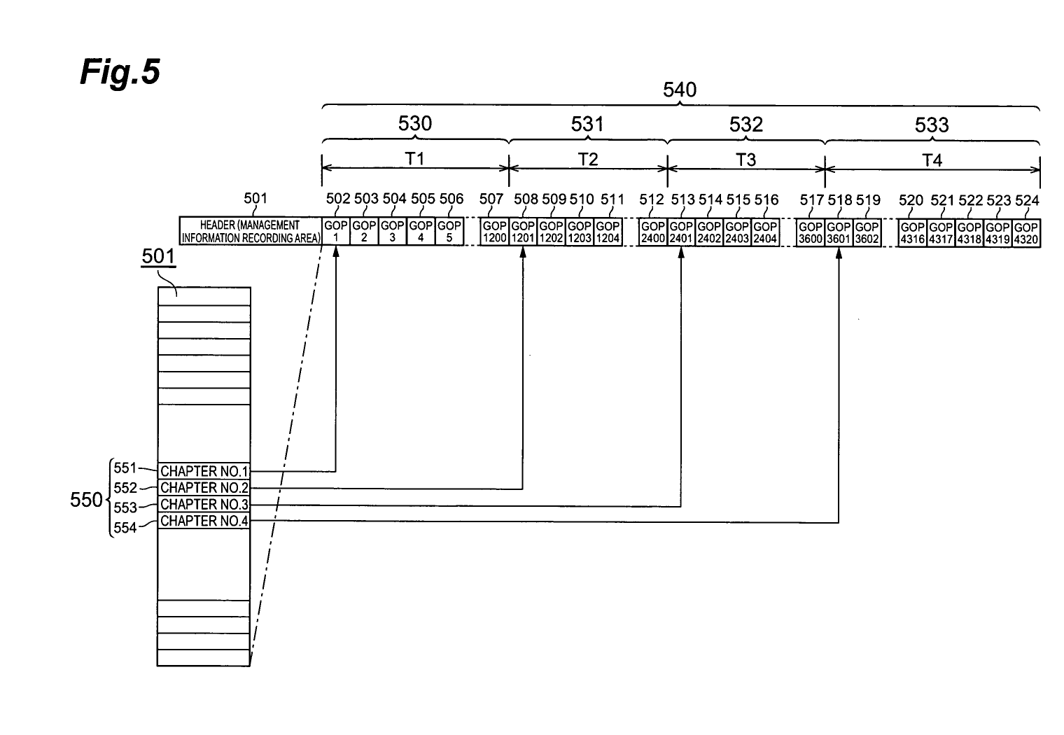

A data stream 540 of the moving image data generated at this time is as shown in FIG. 5. In a chapter table 550 of a header 501, chapter data 551, 552, 553, 554 are recorded. The chapter data 551, 552, 553, 554 respectively record time point information corresponding to GOPs 502, 508, 513, 518, and respectively specify reproduction start points of the moving image data corresponding to the times (times t2, t3, t4) when the scene changes occur. A period from a time when the GOP 502 is generated till the time when the GOP 508 is generated is the chapter insertion time T1. Similarly, periods from the GOP 508 to the GOP 512, from the GOP 513 to the GOP 517, and from the GOP 518 to the GOP 524 are chapter insertion times T2, T3, T4, respectively.

As stated above, in the camera apparatus 100, chapter data is generated when the scene change occurs during the shooting (while generating the moving image data), and the chapter data is recorded at every chapter insertion time.

In the camera apparatus 100, if the CPU 114 detects pan information or tilt information based on the camera shake information detected by the camera shake compensation sensor 120, it is dealt as the scene change during the shooting has occurred and the chapter automatic insertion is realized. In other words, in the camera apparatus 100, detection of the pan information or the tilt information by the CPU 114 is regarded as detection of the scene change during the shooting, and it is judged whether or not the scene change has occurred depending on whether or not the pan information or the tilt information is detected (details will be described later).

By realizing the chapter automatic insertion, the camera apparatus 100 enables easy and quick movement to a point desired to be viewed among the long shot video, when the shot video is to be reproduced, while the operation at the time of shooting is simplified (this will also be described later).

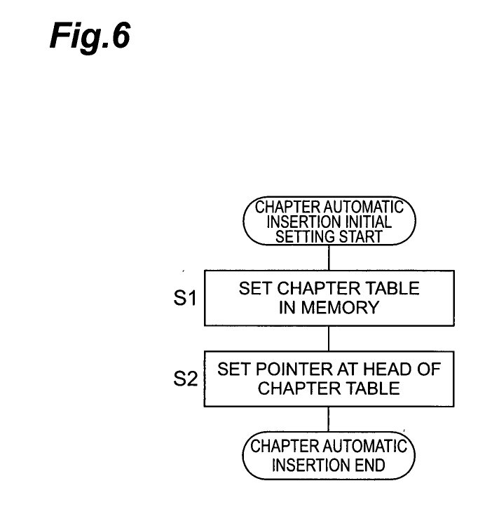

In order to realize the chapter automatic insertion, the camera apparatus 100 performs an operation in accordance with flowcharts shown in FIG. 6 to FIG. 8.

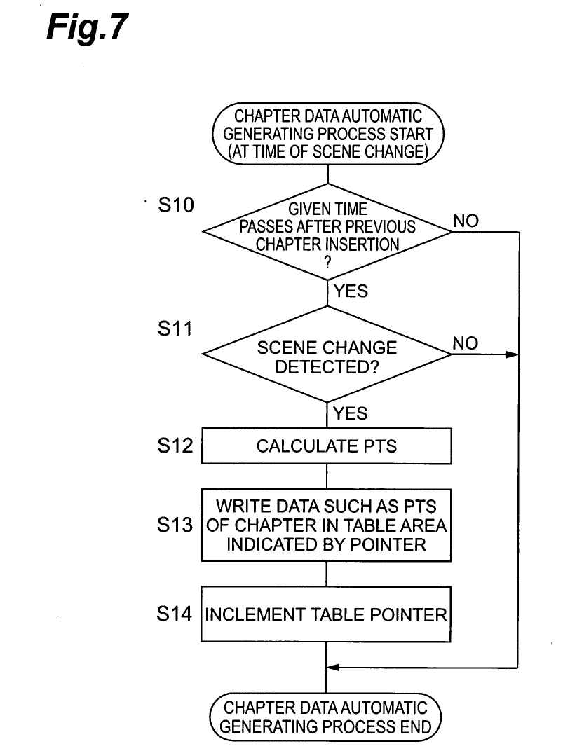

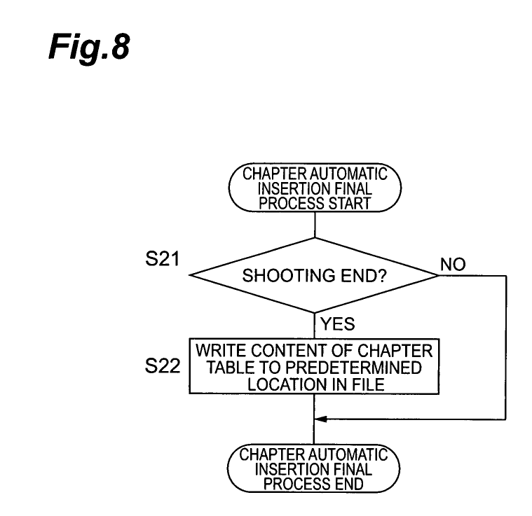

FIG. 6 is the flowchart showing an initial setting procedure of the chapter automatic insertion, FIG. 7 is the flowchart showing an operating procedure of a chapter data automatic generating process, and FIG. 8 is the flowchart showing an operating procedure of a final process of the chapter automatic insertion.

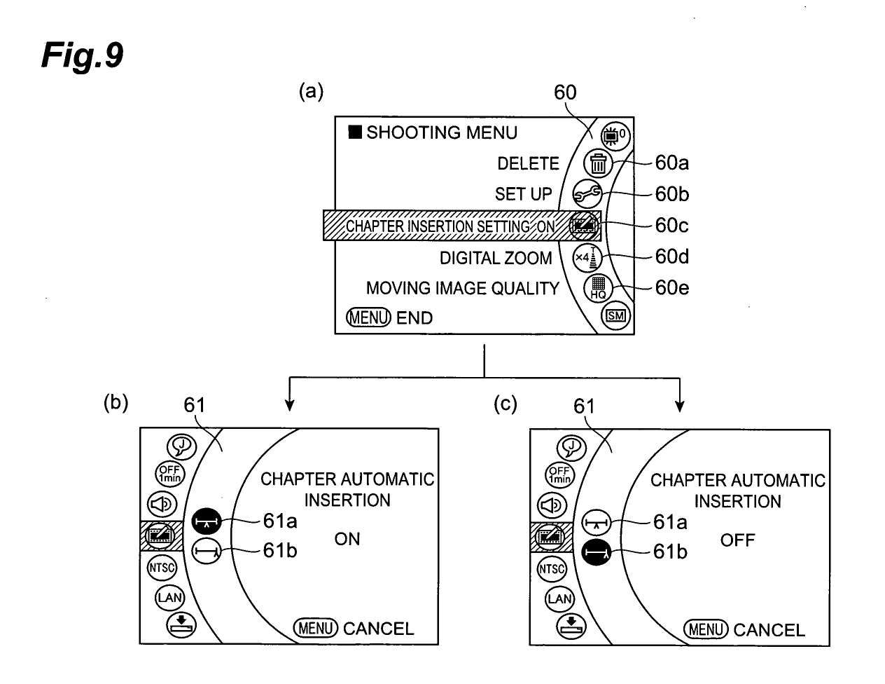

In order that the chapter automatic insertion is performed by the camera apparatus 100, the user first carries out a setting for performing the chapter automatic insertion in accordance with an operation window shown in FIG. 9(a) to FIG. 9(c).

In this case, in a state that a shooting menu is displayed on the LCD 109 as shown in FIG. 9(a), the user operates the operation device 115 and selects an icon 60c of “chapter insertion setting” among a plurality of icons such as icons 60a, 60b, 60c, 60d, 60e included in an icon display part 60.

When the chapter automatic insertion is to be performed, the user operates the operation device 115 and selects an icon 61a included in an icon display part 61 as shown in FIG. 9(b). When the chapter automatic insertion is not to be performed, the user selects an icon 61b included in the icon display part 61 as shown in FIG. 9(c). When the icon 61a is selected, “chapter automatic insertion ON” is displayed, while when the icon 61b is selected, “chapter automatic insertion OFF” is displayed. In this case, the operation device 115 constitutes a switching device switching whether or not to generate the chapter data.

When the user selects the icon 61a, setting of the chapter automatic insertion is turned on and the CPU 114 performs the initial setting operation of the chapter automatic insertion in accordance with the flowchart shown in FIG. 6, simultaneously with start of shooting or before the start of shooting in advance.

In this case, the CPU 114 sets a table area for the chapter table 330 in the memory 104 (S1), sets a pointer at a beginning of the table area (S2) and terminates the initial setting operation.

When the CPU 114 detects the pan information or the tilt information based on the camera shake information detected by the camera shake compensation sensor 120, the CPU 114 generates the chapter data in accordance with the flowchart shown in FIG. 7 and records the generated chapter data in the chapter table 330 in accordance with the flowchart shown in FIG. 8.

Then, the CPU 114 performs an operation as a judging device, and judges whether or not a given time has passed from the generation of the previous chapter data (S10). When the given time has passed, the CPU 114 proceeds to S11, and when the given time has not passed, the CPU terminates the chapter automatic insertion process.

When the CPU 114 proceeds to S11, the CPU performs an operation as a scene change detection unit, and judges whether or not the scene change has occurred based on the camera shake information. In this case, if the camera shake information exceeds a predetermined reference value and is a value of a range for which the camera shake compensation is not performed, it can be dealt as the pan information or the tilt information is detected.

The pan information is data indicating that movement in a pan direction exceeds a predetermined range, while the tilt information is data indicating that movement in a tilt direction exceeds a predetermined range. When the movement in the pan direction or in the tilt direction exceeds the predetermined range, the user is often shooting another scene. Therefore, if the chapter data is generated in that case, the chapter data can be generated at a desirable point. With an attention being focused on this point, the camera apparatus 100 detects the pan information or the tilt information.

When the scene change occurs, the CPU 114 calculates PTS (Presentation Time Stamp) (S12), writes the data such as calculated PTS in an area indicated by a pointer in the table area (S13), subsequently adds “1” to a table pointer (S14), and terminates the chapter data automatic generating process.

When the final process of the chapter automatic insertion starts, the CPU 114 judges whether or not the shooting has ended (S21). If the shooting has ended, the data in the table region secured in the memory 104 is recorded in the chapter table 330 (S22) and the operation is terminated.

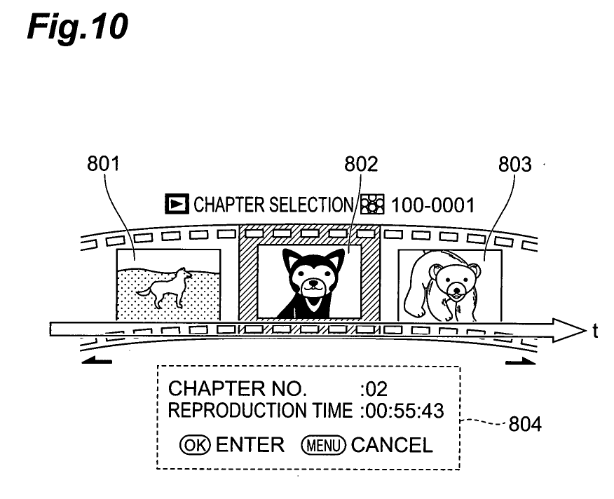

Here, FIG. 10 shows an example of a case that the moving image data divided into chapters by the chapter automatic insertion is displayed on the LCD 109. As shown in FIG. 10, three chapter images 801, 802, 803 are simultaneously displayed on the LCD 109. Each chapter image 801, 802, 803 is a still image displayed by using the GOP 508, 513, 518 corresponding to the chapter data 552, 553, 554.

The chapter images 801, 802, 803 are disposed along the time axis t. The chapter image 802 displayed in a center corresponds to the chapter data 553, while the chapter image 801 displayed in a left side corresponds to the chapter data 552 existing temporally therebefore, and the chapter image 803 displayed in a right side corresponds to the chapter data 554 existing temporally thereafter.

The chapter image 802 in the center is a still image representing a chapter the user is selecting, and a chapter number of this chapter and time point information are displayed in a display area 804.

By the operation device 115, the chapter images 801, 802, 803 are sequentially switched and displayed along an order of the time axis. After the chapter image 802 which the user desires to start reproducing is displayed in the center, the user can operate the operation device 115. Then, the CPU 114 gives instructions to the HDD 105 and the like so that the reproduction is started from the GOP corresponding to the chapter number of the chapter image 802. Hereby, the reproduction of the shot video can be started from the selected chapter.

As stated above, due to the chapter automatic insertion, the chapter data is automatically generated by the scene change being detected during the shooting, and therefore, the camera apparatus 100 can effortlessly divide the moving image data into a plurality of chapters to record the moving image data.

Accordingly, by using the camera apparatus 100, it is possible to automatically generate chapter data, without the user being especially conscious during shooting. Further, when the user reproduces a shot video, it is possible to easily move to a scene the user likes to view and to reproduce therefrom, instead of reproducing from the beginning.

In a conventional camera apparatus, a user is required to manually insert chapter data, but in the camera apparatus 100, such a labor can be reduced.

Further, the camera apparatus 100 judges whether or not the given time has passed since the prior chapter data generation and detects the scene change only when the given time has passed (S10), and therefore, incorrect chapter data generation due to malfunction of pan detection and tilt detection is prevented.

Here, the above described camera apparatus 100 includes the HDD 105 as an external memory apparatus capable of reading/writing data based on a random access; however, a DVD drive for recording data to a DVD (Digital Versatile Disk) may be employed as well as the HDD 105. Here, with the DVD drive, moving image data can be stored in a rewritable memory medium such as a DVD-RW and DVD-RAM.

The above description is to describe an embodiment of the invention and the apparatus and method are not limited by the above description so that various modifications can be embodied with ease. Further, the apparatus and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising
a chapter data generating unit generating chapter data specifying a reproduction start point of moving image data corresponding to a time point at which a scene change occurs, when the scene change occurs during generation of the moving image data indicating a shot video.

2. A camera apparatus comprising:
a moving image data generating device generating moving image data indicating a shot video;
a scene change detection unit detecting a scene change during generation of the moving image data by said moving image data generating device; and
a chapter data generating unit generating chapter data specifying a reproduction start point of the moving image data corresponding to a time point at which the scene change is detected, when the scene change is detected by said scene change detection unit.

3. The camera apparatus according to claim 1, further comprising
a camera shake information generating device generating camera shake information,
wherein said chapter data generating unit generates the chapter data, it being dealt as the scene change has occurred when pan information or tilt information is detected based on the camera shake information generated by said camera shake information generating device.

4. The camera apparatus according to claim 2, further comprising
a camera shake information generating device generating camera shake information,
wherein said scene change detection unit detects the scene change by detection of pan information or tilt information based on the camera shake information generated by said camera shake information generating device.

5. The camera apparatus according to claim 1, further comprising
a switching device switching whether or not to generate the chapter data by said chapter data generating unit.

6. The camera apparatus according to claim 2, further comprising
a switching device switching whether or not to generate the chapter data by said chapter data generating unit.

7. The camera apparatus according to claim 2, further comprising
a judging unit judging whether or not the scene change is detected by said scene change detection unit after a given time passes since the chapter data is generated by said chapter data generating unit.

8. A chapter data generating method in a camera apparatus provided with a moving image data generating device generating moving image data indicating a shot video, the method comprising
generating chapter data specifying a reproduction start point of the moving image data corresponding to a time point at which a scene change occurs, when the scene change occurs during generation of the moving image data by the moving image data generating device.
